(19) United States
(12) Patent Application Publication
(10) Pub. No.: US 2025/0229391 A1
(43) Pub. Date: Jul. 17, 2025

(54) ROTATING T-CLIP INSTALLATION TOOLS AND METHODS OF USE

(71) Applicant: Grabber Construction Products, Inc., Highland, UT (US)

(72) Inventors: Andrew E. Reed, Trumbull, CT (US); Christopher D. Hageman, Glastonbury, CT (US); David Mathieu, Ocala, FL (US); John Jason Roxburgh, Lake Wylie, SC (US); Garrett Fink, Glastonbury, CT (US); Zoran Sekulovski, Bitola (MK)

(21) Appl. No.: 18/926,137

(22) Filed: Oct. 24, 2024

Related U.S. Application Data
(60) Provisional application No. 63/592,755, filed on Oct. 24, 2023.

(51) Int. Cl. B25B 23/04; E04F 15/02

(52) U.S. Cl. CPC B25B 23/045; E04F 15/02044; E04F 2015/02122

(57) ABSTRACT

A clip strip installation system comprising an adjustable base with a removably attaching tool body. The tool body has mechanisms for receiving and feeding through the tool body a clip of collated deck installation clips. One clip at a time is disposed within an installation chamber, where a vertical bit is rotated to drive a fastener of the clip into a support structure, such as a joist. The process of removing the bit causes automatic reloading of the chamber with the next clip in the strip without the need for a motor or power source.

### CROSS-REFERENCE TO RELATED APPLICATIONS

This application claims the benefit of U.S. Prov. Pat. App. Ser. No. 63/592,755, filed Oct. 24, 2023, the entirety of which is incorporated herein by reference.

### BACKGROUND OF THE INVENTION

### Field of the Invention

This disclosure is related to the field of construction, and more particularly to a hidden fastener system for rapid installation of decking.

### Description of the Related Art

Residential decks serve as versatile outdoor living spaces that provide numerous functions, uses, and benefits to homeowners. They serve as extensions of the indoor living area, allowing people to enjoy the outdoors comfortably. Decks are commonly used for various activities such as hosting gatherings, barbecues, relaxing, and spending quality time with family and friends. They offer a designated space for outdoor furniture, plants, and décor, allowing homeowners to create a personalized and inviting outdoor oasis. Residential decks also provide an excellent vantage point to appreciate the surrounding landscape and enjoy fresh air. Additionally, decks can increase the overall value of a property, enhance its curb appeal, and provide a desirable feature for potential buyers. Their popularity stems from the fact that they offer a convenient and enjoyable way to expand living space, connect with nature, and create a seamless transition between indoor and outdoor areas.

The installation process of a residential deck typically involves clearing the area where the deck will be installed of vegetation or debris, leveling the ground, and setting footings or piers to establish a foundation. The footings support the deck's weight and lend structural stability by transmitting loads to the Earth. Once the footings are placed, vertical posts are installed, and beams are attached to the posts to create the framework of the deck. Joists are then attached to the beams to form a base for the deck surface, which are then attached to the base by installing the decking-usually planks of treated lumber or composite materials-on the joists. Finally, railings, stairs, and decorative features may be added.

This process, though simple in concept, can be challenging, time-consuming, and expensive. Precise measurements are required, along with accurate leveling, structural calculations, and proper use of construction techniques to ensure safety and stability. The installation of the deck surface, whether lumber or composite materials, often involves cutting, fitting, and fastening numerous boards, a demanding and time-consuming process. Installing the actual decking can be challenging due to several factors. Ensuring proper alignment and spacing of the deck planks requires precise measurement and attention to detail to ensure consistency and an aesthetically pleasing appearance. Also, fastening the deck boards securely is important to stability and longevity, and may require specialized tools or equipment. Ensuring that the fasteners are correctly driven into the appropriate locations without damaging the boards or fasteners is a precise operation, especially when dealing with different board lengths and angles, and if the installer is not careful, the fasteners may be misaligned with the underlying joists and miss them entirely. This work is often done while working high above the ground, where workers' attention is focused elsewhere, increasing fall risk.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a deck clip installation system comprising: a clip strip comprising a plurality of deck installation clips removably attached to a backing; a base element comprising: a first end having a generally U-shaped cross-section comprising a top having two side rails extending downward from opposing lateral edges thereof, and a first adjustable gripping element; a second end opposing the first end and defining a major axis extending from the first end to the second end, the second end comprising a second adjustable gripping element; and a locking pin disposed through a side of one of the side rails; wherein each of the two side rails extend to the second end and comprise a receiving notch disposed on a top side thereof and a locking notch disposed on a distal end thereof; and a tool body comprising: an installation chamber disposed within the tool body and adapted to receive a deck installation clip from the clip strip; a channel disposed through the tool body from a front end proximal the first end to a back end proximal the second end, the channel intersecting the installation chamber and having a track on a bottom surface adapted to receive, and defining a feed path of, the clip strip; a holder operable to inhibit movement of the clip strip through the channel toward the back end; a pusher operable to reciprocally and incrementally advance the clip strip through the channel toward the front end;

a vertical actuator slidingly disposed in the tool body above the installation chamber, the vertical actuator comprising a vertical channel extending from a top side to a bottom side thereof, the vertical actuator vertically tensioned in the tool body by a spring; a driver bit comprising a bit collar proximal a top end thereof, and an opposing bottom end disposed in the tool body, and an elongated body extending therebetween, at least part of the elongated body vertically slidingly disposed in the tool body, and at least part of the elongated body vertically slidingly disposed in the vertical channel of the vertical actuator; a first set of engagement pins disposed on opposing lateral sides of the tool body proximal the front end and a second set of engagement pins disposed on opposing lateral sides of the tool body proximal the back end; and a locking receiver disposed on a lateral the of the tool body; wherein the tool body is removably attachable to the base element by sliding the first set of engagement pins into the receiving notches and sliding the second set of engagement pins into the locking notches until the locking pin engages the locking receiver.

In an embodiment of the deck clip installation system, the base element further comprises at least one opening in the top side.

In another embodiment of the deck clip installation system, the base element further comprises a strip guide on the top side.

In another embodiment of the deck clip installation system, the first gripping element comprises a fin having a major plane generally perpendicular to the major axis, and an adjustable arm extending generally perpendicularly from the fin, the adjustable arm slidingly and adjustably attachable and lockable to one of the side rails by locking hardware.

In another embodiment of the deck clip installation system, the second gripping element comprises at least one fin having a major plane generally perpendicular to the major axis, and at least one adjustable arm extending generally perpendicularly from the fin, the adjustable arm slidingly and adjustably attachable to an adjusting wing extending laterally outward from at least one of the side rails proximal to the second end.

In another embodiment of the deck clip installation system, the holder is attached to an interior surface of the tool body on a first side of the channel and installation chamber, and comprises a flexing arm having a pawl at a distal end thereof, the pawl extending into the feed path when the arm is unflexed, and the pawl laterally movable out of the feed path when the flexing arm is flexed, the pawl sized and shaped to inhibit movement of a strip of deck installation clips disposed in the channel toward the back end.

In another embodiment of the deck clip installation system, the bit collar has a radius larger than a radius of a top opening of the vertical channel in the vertical actuator.

In another embodiment of the deck clip installation system, when the bit driver is lowered into the tool body a distance effective to cause the bit collar to contact the top opening, lowering the bit driver further causes the vertical actuator to be lowered into the tool body.

In another embodiment of the deck clip installation system, when the lowered bit driver is raised from the tool body a distance effective to cause the bit collar to detach from the top opening, the spring causes the vertical actuator to be raised from the tool body to a neutral position.

In another embodiment of the deck clip installation system, the vertical actuator comprises an angled surface on a bottom side thereof.

In another embodiment of the deck clip installation system, the pusher comprises a main body pivotably attached to the interior of the tool body at a pivot point.

In another embodiment of the deck clip installation system, the main body is slidingly, along the major axis, attached to the main body at the pivot point.

In another embodiment of the deck clip installation system, the pusher further comprises an actuating arm extending from a first end of the main body proximal the front end, the actuating arm having an angled surface on a top side thereof.

In another embodiment of the deck clip installation system, the pusher further comprises a tensioning arm extending from a second end of the body element opposing the first end and proximal the back end, the tensioning arm tensioned in the rearward direction against an interior surface of the tool body by a spring.

In another embodiment of the deck clip installation system, the pusher further comprises a pawl extending from a lateral side of the main body, the pawl at least partially disposed in the feed path when the pusher is in a neutral position.

In another embodiment of the deck clip installation system, the angled surface of the vertical actuator is disposed above the angled surface of the pusher in the tool body, and when the vertical actuator is lowered into the tool body a distance effective to cause the angled surface of the vertical actuator to contact the angled surface of the pusher, lowering the vertical actuator further causes the pusher to slide towards the back end and to pivot away from the feed path.

In another embodiment of the deck clip installation system, when the pusher slides towards the back end and pivots away from the feed path to a maximum extent, the pawl advances the clip strip toward the front end a distance effective to advance a deck installation of the clip strip into the installation chamber.

In another embodiment of the deck clip installation system, each of the deck installation clips comprises a rotating T-clip assembly.

### BRIEF DESCRIPTION OF THE DRAWINGS

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

FIGS. 1, 2A and 2B depict embodiments of a rotating T-clip to be installed using installation tools according to the present disclosure.

FIGS. 3 and 4 depict a rotating T-clip assembly strip for use with an installation tool according to the present disclosure.

FIG. 5 depicts a cross-sectional view of an installation tool in use according to the present disclosure.

FIGS. 6A and 6B depict isometric views of the installation tool of FIG. 5 in assembled and exploded views, respectively.

FIGS. 7, 8, and 9 depict plan views of the tool in use, demonstrating the movement and relationship of various internal components.

FIGS. 10A, 10D, and 10G depict side views of the tool in use, demonstrating the movement and relationship of various internal components.

FIGS. 10B, 10E, and 10H depict plan views of the tool in use, demonstrating the movement and relationship of various internal components.

FIGS. 10C, 10F, and 10I depict top down views of the tool in use, demonstrating the movement and relationship of various internal components.

FIGS. 11A and 11C depict plan views of the tool in use, demonstrating the movement and relationship of various internal components.

FIG. 11B depicts a top down view of the tool in use, demonstrating the movement and relationship of various internal components.

FIGS. 12-13 depict cutaway views of the tool in use, demonstrating the movement and relationship of various internal components.

FIG. 14 depict a mechanism for disengaging the internal components from a clip strip.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

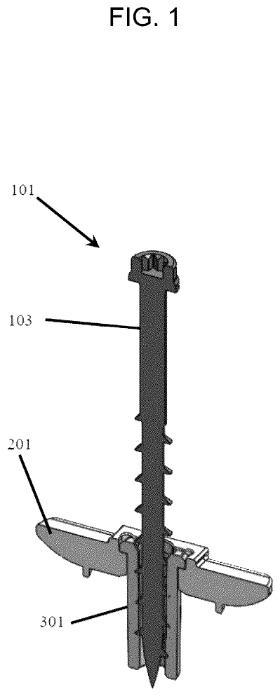

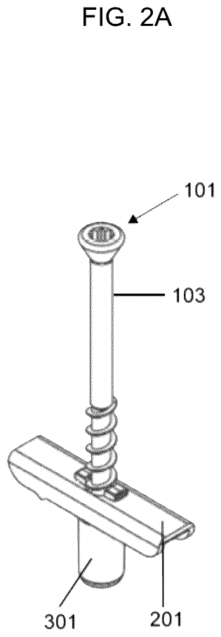

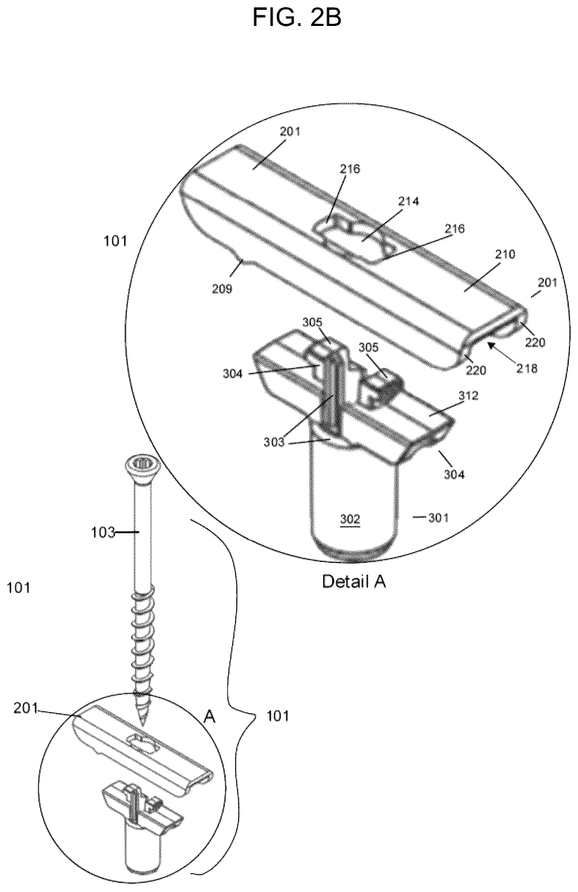

Described herein, among other things, are installation tools, and methods of use in the installation of rotating T-clips with decking to achieve consistent board spacing and installation height. Exemplary embodiments are shown in FIGS. 1, 2A, and 2B. At a high level of generality, the T-clips comprise a wing element (201), collar element (301), and fastener element (103), which are assembled for insertion in the gap between adjacent deck boards (401). Once the wing element (201) has descended beyond the gap and into the recessed spaces beneath the deck board (401) surface, the wing element (201) is rotated by the rotational motion of a driving means (e.g., a drill) until engaging elements (209) connect with the surfaces of the recessed spaces. The collar element (301) then experiences partial compression as the fastener (103) is driven between the deck boards (401), achieving a clean, aesthetically pleasing look. Installation tools (601) may be used to assist with spacing of the deck boards (401) and rapid loading and deployment of the rotating T-clips (101) in succession for speed and efficiency.

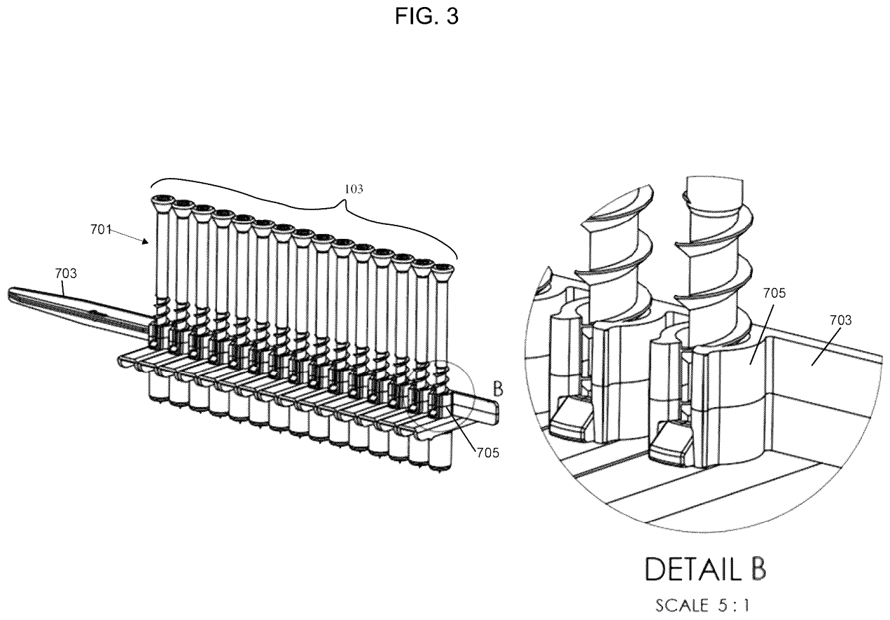

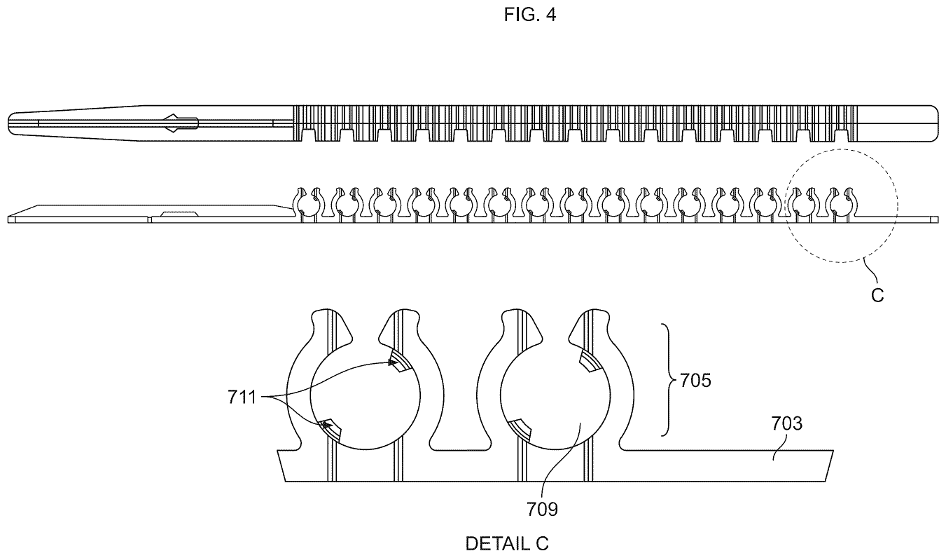

FIGS. 3-4 depict exemplary embodiments of a clip strip (701) for use with the installation tools described herein. In this depicted embodiment, the clip (701) comprises a backing strip (703), generally in the configuration of an elongated, flat element, preferably made from a flexible material capable of deformation and returning to its natural shape. As shown, the backing strip (703) has attached thereto along one side a sequence of holding elements (705), each configured to retain a rotating T-clip assembly (101). The depicted holding elements (705) are generally in the configuration of a partial ring, circle, or a roughly horseshoe-like shape. This opening allows a rotating T-clip assembly (101) to be inserted into and removed from the open middle (709) of the holding element (705) to be held there. The interior surface of the holding element (705) may comprise additional elements to assist with retention, such as small tabs (711).

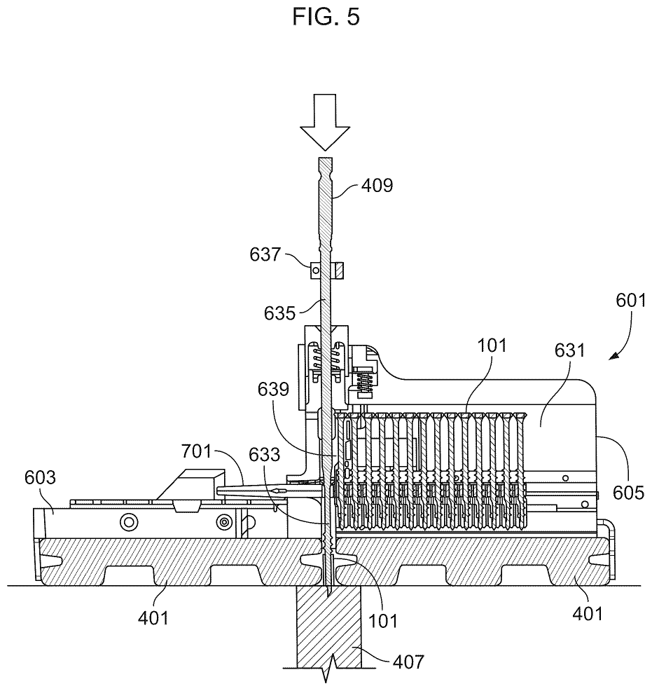

FIG. 5 depicts a cross-sectional view of an installation tool (601) in use with a strip (701) of rotating T-clips (101), deployed in installation position over a pair of adjacent deck boards (401). As seen in the depicted embodiment of FIG. 5, the tool (601) positions a first rotating T-clip assembly (101) from the clip (701) above the gap between the deck boards (401) and aligns the major axis of the wing element (201) lengthwise with the gap. The pointed end of the fastener element (103) is directed downward. When torque is applied to the top of the fastener element (103), the fastener element (103) will drive the rotating T-clip assembly (101) downward, disconnecting it from the strip (701). The rotating T-clip descends between the deck boards (401) until the fastener element (103) contacts the top of the joist (407). As the fastener element (103) penetrates the joist (407), the collar element (301) compresses until the engaging elements (209) contact the bottom of the lateral recesses in the deck boards (401), attaching them to the joists (407).

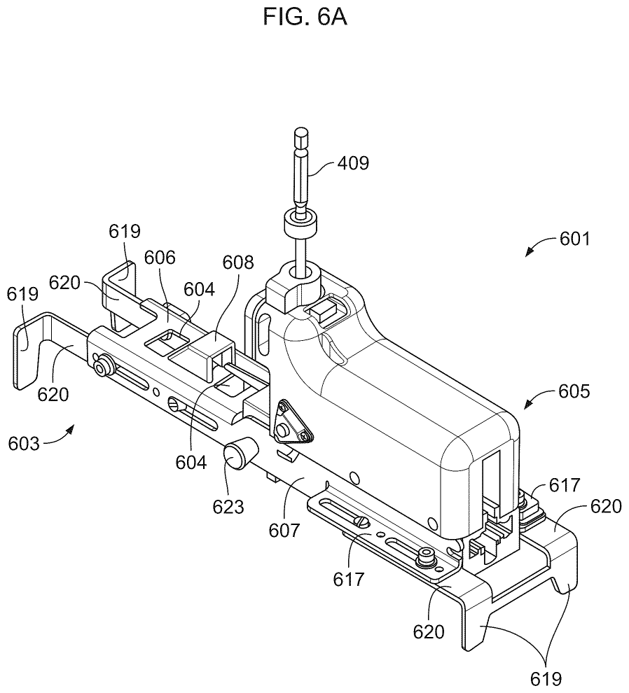

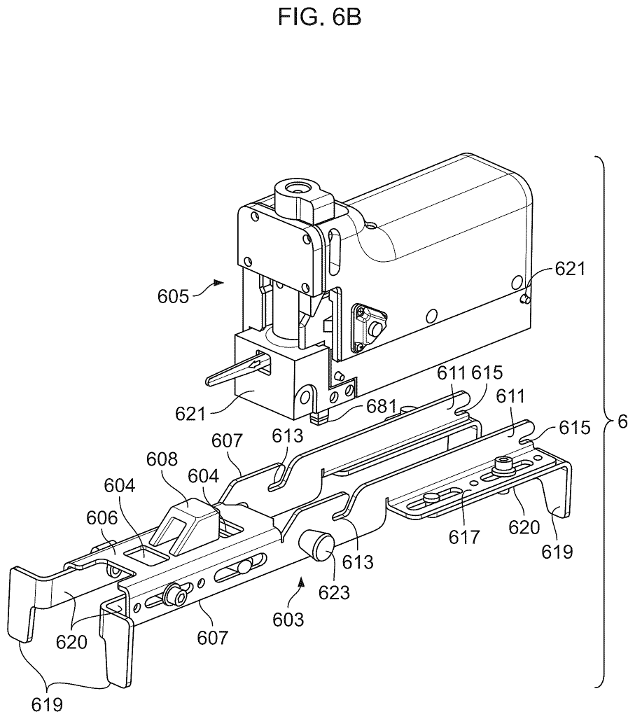

FIGS. 6A and 6B depict isometric views of the tool (601). At a high level of generality, the depicted tool (601) comprises a base element (603), and a tool body (605). In the depicted embodiment of FIGS. 6A and 6B, the tool body (605) is removably attachable to the base element (603).

The depicted tool (601) has no powered components and operates through a combination of sliding, pivoting, and other kinetic elements, mechanically operated through springs and other tensioners. It thus does not require a power supply. Rather, powered torque may be provided via the external tool. The depicted tool (601) is adapted for use with a powered driver, such as an electric drill using a driver bit (409). Because the rotating T-clip assemblies (101) are generally installed vertically (i.e., parallel to gravity) the depicted tool (601) is adapted for use by inserting a driver bit (409) vertically downward into a receiver. For sake of simplicity, only a driver bit (409) is depicted in the FIGs.

The depicted base element (603) has a major axis extending from the attaching end to the installation end, and a perpendicular minor axis. As seen in the FIGs., the configuration of the base element (603) differs at the opposing ends of the major axis. For ease of reference, this disclosure will refer to the two opposing ends of the depicted base element (603) as the installation end and the attaching end, where the attaching end is the end on which the tool body (605) is attached, and the installation end is the opposing end.

In the depicted embodiment, the overall profile shape of the base element (603) at the installation end is roughly that of an upside-down U-shaped cross section, comprising a top (606) connecting two opposing side rails (607) descending downward from the top (606). The depicted outer rails (607) have a generally linear bottom edge, and the bottom edges are also generally collinear, coplanar, and parallel with each other.

The depicted installation end also comprises openings (604) extending vertically through the top (606), which reduce weight and allow the user to view the deck boards (401) under the tool when in use. Two orthogonal openings (604) are shown, but this is not limiting and, in an embodiment, the device may have zero, one, or three or more such openings (604) of varying configurations. Also shown in the FIGs. is a strip guide (608). The depicted strip guide (608) is a tunnel-shaped element, having a front and back opening in-line with the feed direction of the clip strip (701) through the device (described in further detail elsewhere herein). As the rotating T-clip assemblies (101) are deployed and the empty portion of the clip strip (701) is advanced through the tool body (605), the empty portion passes through the tunnel (608) via the openings, which helps to maintain alignment of the clip strip (701) and to prevent the waste portion from uncontrolled movement.

At the attaching end, the base element (603) forks into a pair of opposing receiver arms (611) for removable attachment of the tool body (605), as described elsewhere herein. The depicted receiver arms (611) are generally thin, elongated elements with a receiving notch (613) and a locking notch (615) and are formed as extensions of the side rails (607). The depicted major plane of the receiving arms (611) is generally perpendicular to the major plane of the base element (603). In the depicted embodiment, a pair of opposing lateral adjusting wings (617) extend generally perpendicularly outward from the receiving arms (611), away from the major axis of the base element (603). These adjusting wings (617) are thus generally parallel to the major plane of the base element (603). The primary function of these adjusting wings (617) is to provide a mounting and locking surface for the adjustable grip elements described elsewhere herein. Thus, the depicted adjusting wings (617) have openings for locking hardware.

The depicted base element (603) comprises a pair of opposing gripping elements (619), disposed on the distal ends of the installation end and the attaching end, respectively. The bottom of the depicted base element (603) is generally flat, so that the tool (601) rests on the top of a decking surface without rocking or other unwanted movement. To assist the user in positioning the tool (601) properly, and to inhibit front to back movement in the direction of the major axis, the depicted gripping elements (619) comprise structures configured for disposition between adjacent deck boards (401). In the depicted embodiment, these structures (619) are roughly in the configuration of fins: thin, elongated elements, with a major plane perpendicular to the major axis of the base element (603) (that is, in a direction causing the fins to descend between adjacent deck boards (401)). These fins extend below the bottom of the base element (603). Thus, when the base element (603) is resting on top of the deck boards (401), the fins can descend between the deck boards (401) and hold the base element (603) in place, to reduce or inhibit unwanted movement. The distance between the opposing sets of fins is thus generally about equal to (slightly larger than) a multiple of the combined width of a deck board (401) and space.

In the depicted embodiment, this distance is adjustable, allowing the tool (601) to have a more versatile configuration for use in decking with different board widths. As can be seen in FIGS. 6A and 6B, the set of gripping elements (619) disposed at the installation end are separate elements from the base element (603), and are slidingly attached to the outer rails (607).

These installation end gripping elements (619) comprise fins disposed at a generally perpendicular angle to an elongated adjusting arm (620). This adjusting arm (620) is disposed along the inside surface of the side rails (607) and has openings through which adjustable locking hardware may be disposed to lock the gripping elements (619) in place. Corresponding openings are disposed as shown on the side rails (607). The fins may thus be disposed closer to, or further away from, the distal end of the installation end by loosening the hardware, sliding the adjustable arm (620) away from (or towards) the base element (603), and then retightening the locking hardware. This technique will be familiar to one of ordinary skill in the art.

In the depicted embodiment, there are two gripping elements (619) on the installation end, each disposed on the inside of one of the side rails (607). In an alternative embodiment, there may be only a single gripping element (619). In certain embodiments, one or more gripping elements (619) may be independently adjustable, allowing for deployment in unusual decking configurations. Also, in an embodiment, one or more gripping elements (619) may be removable. In a still further embodiment, the gripping elements (619) may be monolithically formed to move in concert.

In the depicted embodiment, the tool body (605) further comprises a pair of opposing spacers (681) descending downward from bottom lateral sides of the tool body (605), in a location generally in the same vertical plane as the center of the installation chamber. These spacers (681) are disposed between the adjacent deck boards (401) between which the rotating T-clip assembly (101) will be installed, and are generally slightly thicker than the width of the rotating T-clip assemblies (101), so that they force the deck boards (401) to be far enough apart when the tool (601) is in use for the rotating T-clip assemblies (101) to pass between the deck boards (401).

Although a generally fin shaped structure is shown, this is not limiting, and other configurations are possible. The function of the fins is to descend between deck boards (401) and provide a lateral surface that inhibits motion along the major axis. Other shapes may be substituted. The particular configuration and shape will generally depend on the gap between the deck boards (401), and considerations such as manufacturing ease and cost. But, generally, it is desirable that the fins descend far enough between the deck boards (401) that they are not easily dislodged by inadvertent bumping, but do not descend so far that they contact underlaying support structures, such as joists (407), which may lift the bottom of the base element (603) and destabilize the tool (601).

Similarly, the gripping elements (619) on the attaching end may also (or alternatively) be adjustable. In the depicted embodiment, the attaching end gripping elements (619) have a different configuration. Although they each also have an adjusting arm (620) that extends towards the tool body (605), this adjusting arm (620) is disposed so that its major plane is roughly parallel to the major plane of the base element (603), and the fins extend perpendicularly downward from a distal end thereof (rather than outward, as with the installation end). Likewise, the fastening and locking hardware is vertically disposed through the adjusting arm (620), and the adjusting arm (620) is disposed under the adjusting wings (617).

In the depicted embodiment, the gripping element (619) on the attaching end is shown to be a monolithic construction connected by a bar. As with the installation end, this is not limiting, and in an alternative embodiment, this element may comprise two separately adjustable gripping elements (619). Likewise, the particular shape, configuration, depth, and thickness of the fin elements may vary in an embodiment.

When in use, one or both of the opposing gripping elements (619) on each end of the base element (603) may be adjusted to situate the tool body (605). By providing adjustable gripping elements (619) at both ends, configuration is greatly simplified, because the user can adjust both to ensure that the location of the installation chamber (639) is precisely located above the gap between deck boards (401). Another advantage of the gripping elements (619) is that as the tool (601) is slid down the deck surface, the consistent width between the opposing fins will pull warped deck boards (401) into alignment. This will happen shortly before installation, after which the rotating T-clip assembly (101) will attach those deck boards (401) to the joists (407), alleviating the warp. Otherwise, installers generally must use a pry bar to hold a warped board in position, which is more cumbersome, more dangerous, more time consuming, and less accurate.

FIGS. 6A and 6B also demonstrate the removability of the tool body (605) from the base element (603). In the depicted embodiment, the tool body (605) is attached to the base element (603) through a combination of structures. As described elsewhere herein, the base element (603) comprises a pair of opposing receiving arms (611) which provide a mounting surface for the tool body (605). The depicted tool body (605) has two sets of engagement pins (621) disposed on the lateral outer surface thereof at locations corresponding to the locations of the receiving (613) and locking (615) notches in the receiving arms (611).

Thus, the tool body (605) can be installed by inserting a first set of engagement pins (621), disposed proximal to the installation guide (608), into the receiving notches (613), and positioning the rearward set of engagement pins (621) outside of the locking notches (615). The tool body (605) may then be slid forward, causing the forward engagement pins (621) to advance into the receiving notches (613), until a locking mechanism of the main body engages the base element (603). In the depicted embodiment, the tool body (605) is locked in place using a locking pin (623) laterally disposed through one of the side rails to engage with a corresponding locking receiver (624) disposed on the side of the tool body. Once the tool body (605) is engaged with the base element (603), it can be removed by releasing the locking mechanism. In the depicted embodiment, this is done by pulling on a locking pin (623) disposed on a lateral outer edge of the side rails (607). This disengages the lock, allowing the tool body (605) to be reversed backwards out of the receiving notches (613) and the locking notches (615). Such pins (623) are typically tensioned to hold them in locked position while allowing temporary removal to release the lock. This is exemplary only and, in other embodiments, different structures may be used.

An advantage to the removability of the tool body (605) is that it allows the tool (601) to be more easily manipulated in tight spaces, such as in installation locations close to the side of the structure to which a deck is being installed, where there may not be sufficient room to fully deploy the base element (603). In such situations, the tool body (605) may be used to install without use of the base element (603).

The tool body (605) has various internal structures and systems for facilitating the installation of rotating T-clip assemblies (101) from a clip strip (701). Generally, these include: a holding system, for maintaining a rotating T-clip assembly (101) within an installation chamber (639); an advancing system, for advancing the clip strip (701) through the tool body (605) and position the next assembly (101) in the strip (701) in the installation chamber (639) for use. Preferably, these systems are adapted to operate automatically with ordinary use of the tool (601). That is, when the user installs a first assembly (101), the mechanical components which facilitate that installation are also operable to cause the advancing system to advance the clip (701) and position the next assembly (101) for installation. This automatic chambering improves installation speed and efficiency by eliminating steps for the user to perform manually.

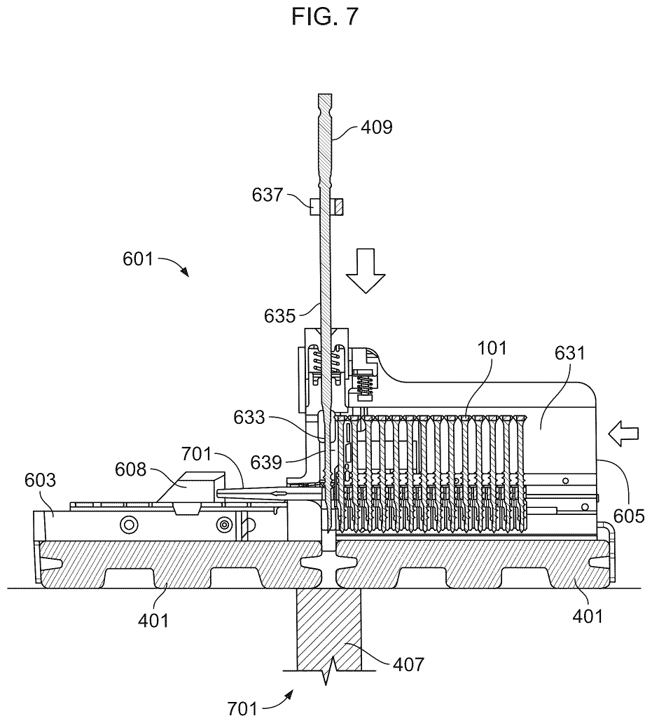

FIGS. 7-11C depict an embodiment of such systems and a non-limiting, exemplary embodiment of use. At a high level of generality, the depicted steps are: position driver bit (409) to engage with fastener; downward motion of the driver bit (409) without torque to position the wing element (201) between the deck boards (401); apply torque to the driver bit (409) to engage the wing element (201) in the recesses; advance the driver bit (409) until installation is complete; and, disengage and withdraw the driver bit (409), operating the advancing system to position the next assembly (101). These and other aspects are described in further detail elsewhere herein.

FIG. 7 depicts a first step and various components. For clarity and simplicity, FIGS. 7-11C do not label all visible elements. In FIG. 7, the tool body (605) comprises a fully or partially internal installation chamber (639) sized and shaped to hold a deck clip (101) in position for installation, generally coaxially with the direction of the driver bit (409). Also, the tool body (605) has a feed channel (631) extending from a back end of the tool body (605) through the internal structure of the tool body (605) and intersecting with the installation chamber, with an egress point at the front end of the tool body (605). The channel bottom is generally in the configuration of a feed track, with a contour or shape corresponding and/or matching that of the clip strip (701), allowing the clip strip (701) to be held in an upright orientation and slide through the tool body (605) during use.

A clip strip (701) loaded with uninstalled rotating T-clip assemblies (101) is fed into the feed channel (631) from the back side, until the front end of the strip (701) extends from the tool body (605) towards the guide (608). In this position, the first uninstalled rotating T-clip assembly (101) and/or (633) in the strip (701) is disposed in the installation chamber (639). The strip (701) is inhibited from rearward movement (i.e., towards the back end of the tool body (605) by a holder (649)). In the depicted embodiment, the holder (649) is a flexible element attached to the inside of the tool body (605) to one side of the feed path, with a flexible arm (659) extending along the feed path and ending in a pawl (657) that extends into the feed path when the arm (659) is in neutral position. The front side of the depicted pawl (657) is flat, and thus provides a bracing surface for inhibiting rearward movement of the clip strip (701). The back side of the depicted pawl (657) is angled relative to the direction of the feed path, and thus, when the clip strip (701) is advanced forward, the pawl (657) is pushed laterally outward, away from the feed path, until the next clip (101) in the strip (701) passes the pawl (657), after which it can snap back into neutral position to again inhibit unwanted rearward motion.

The tool (601) may further comprise a driver bit (409) slidingly installed in the tool body (605) from the top side. The lower end of the driver bit (409) is configured to engage the head of the fastening element (103) and the opposing end is configured to be engaged by a power drill chuck. Also disposed near the top end is a bit collar (637). The depicted collar (637) is generally in the configuration of a cylinder, but other shapes are possible. The function of the bit collar (637) is, as described elsewhere herein to engage the vertical actuator (641) and lower it, thus operating other internal components. The bit driver (409) also comprises an elongated body (635) extending into the tool body (605). The length of this body (635), and the position of the collar (637) are selected relative to the dimensions of other tool components to install the deck clips (101) at the proper depth while also effective to operate the advancing mechanism described elsewhere herein. The driver bit (407) may be a single monolithic construction with the body (635) and/or color (637), or may be a separate element (e.g., a bit for use with an external drill) that is temporarily attached to the top of the body (635) to drive the fastener element (103), and then removed after use to reposition the tool (601) for the next installation.

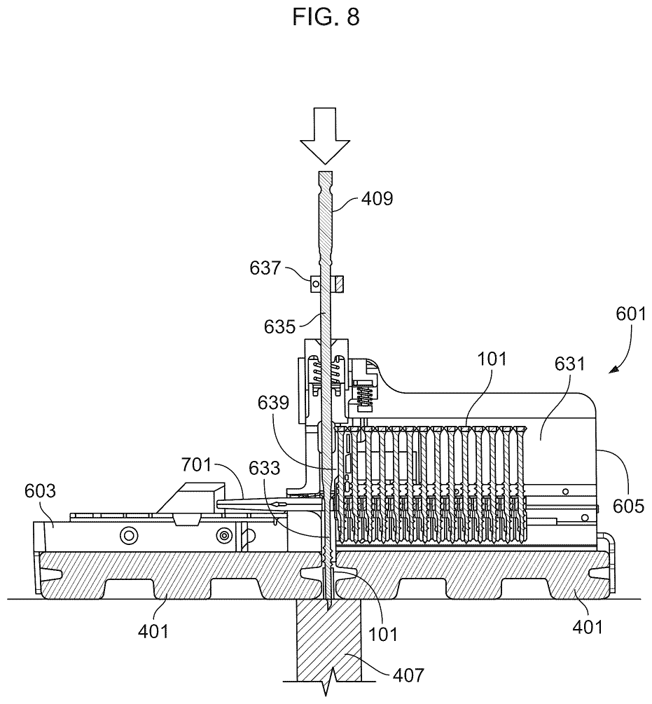

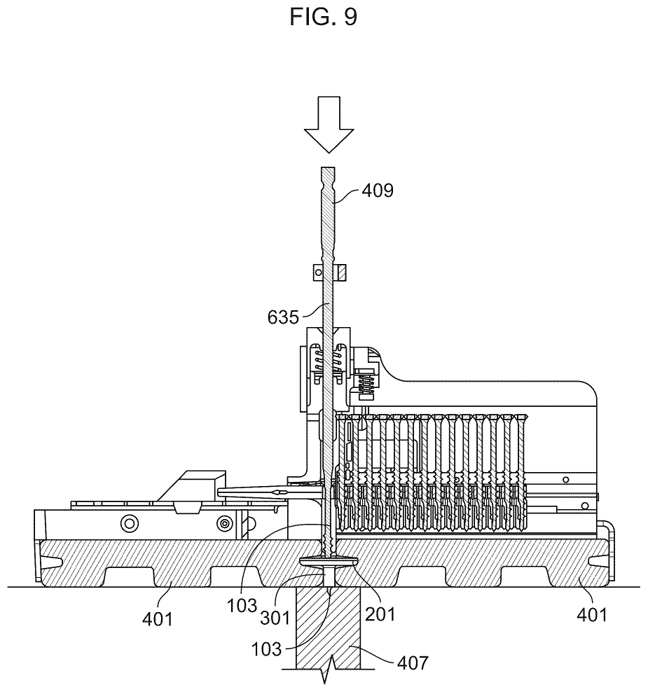

In FIG. 8, the next step, the driver bit (409) is first moved downward without the application of torque. This is because the wing elements (201) in the clip strip (701) are aligned in the clip strip (701) so that when the clip strip (701) is fed into the feed channel (631), the major axis of the wing elements (201) is generally parallel to the direction of the spaces between the deck boards (401), so that the rotating T-clip assembly (101) can descend between the deck boards (401). If torque is applied before the wing elements (201) pass between the deck boards (401), the wing elements (201) may become misaligned and undesirably engage with the top of the deck boards (401). Thus, the next step is to push down without the application of torque until the wing elements (201) clear the top of the deck boards (401) and are disposed adjacent the recesses, as shown in FIG. 7. This is preferably also the point at which the tip of the fastening element (103) contacts the joist (407), providing a natural stopping point for the downward motion. This also disengages the collar (301) and wing (201) elements from the clip strip (701). However, because the fastening element (103) has not yet cleared the strip (701), it is not yet desirable to attempt to advance the strip (701). In FIG. 9, torque is applied, causing the engaging elements (209) to dig into the recesses, and the fastening element (103) to begin to penetrate the joist (407). In this step, the fastening element (103) is further advanced through the clip strip (701).

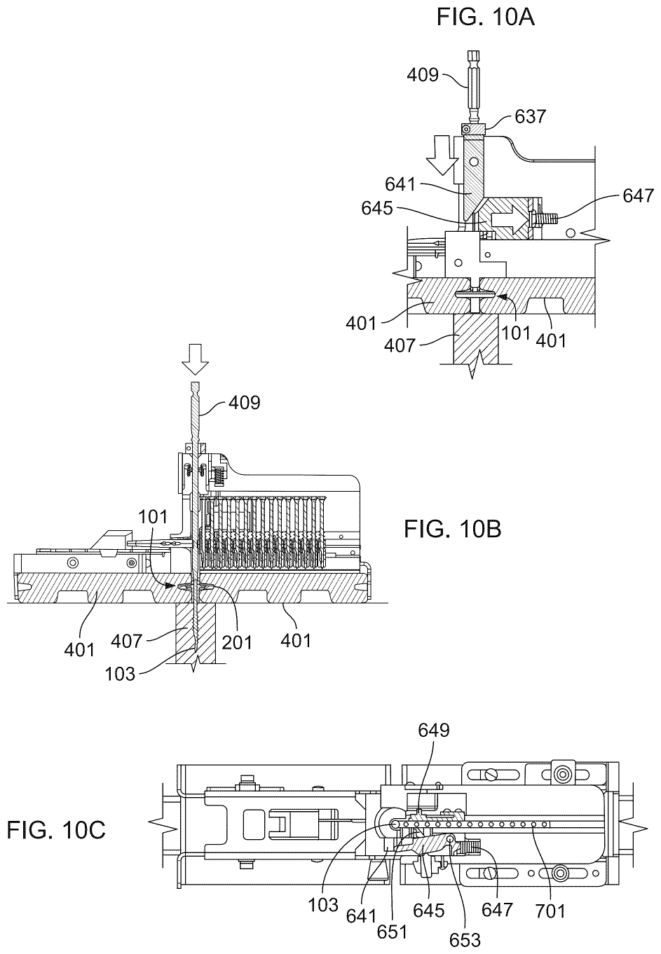

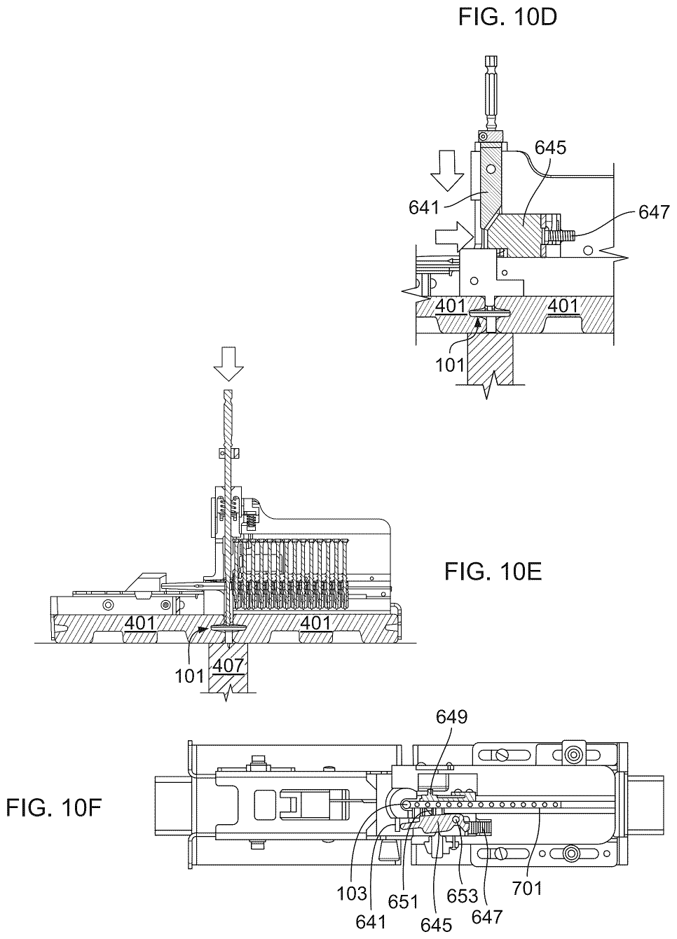

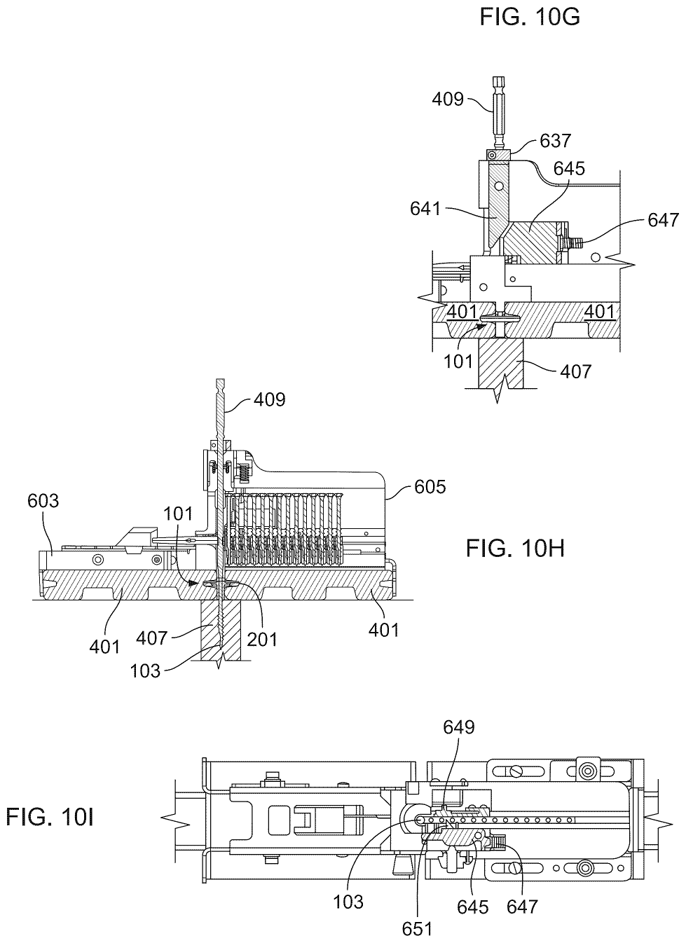

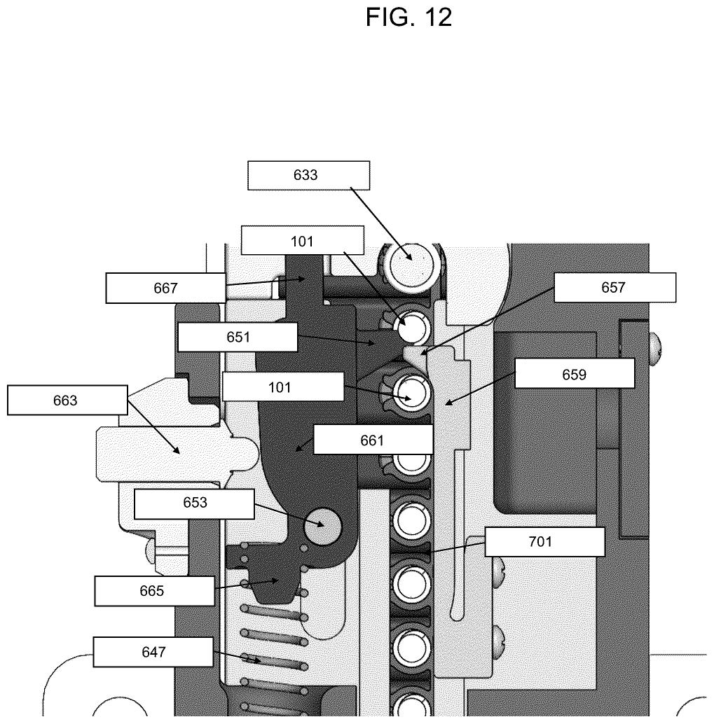

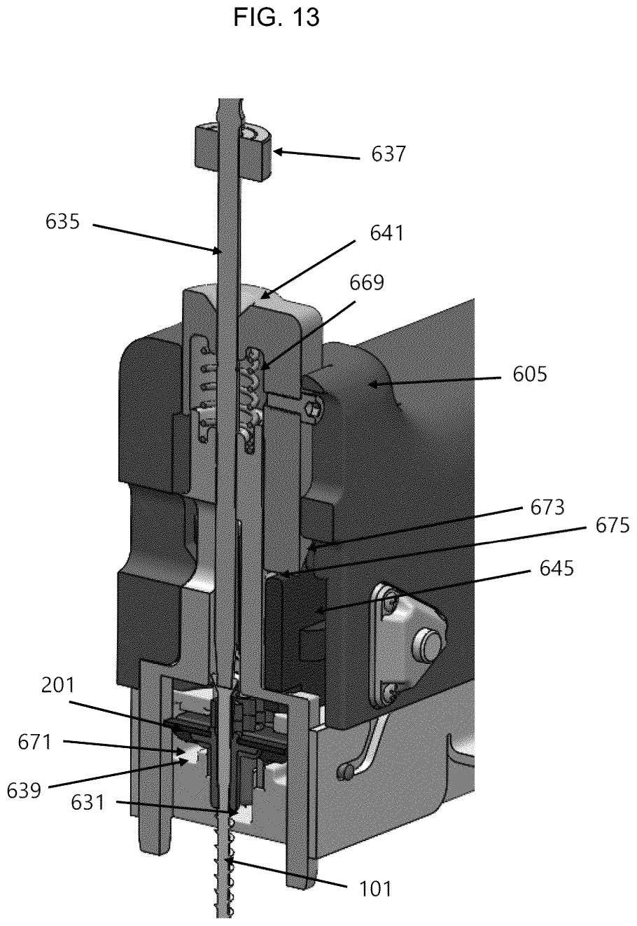

In FIGS. 10A, 10B, 10C, 10D, 10E, 10F, 10G, 10H, and 10I torque continues to be applied to drive the fastening element (103) further into the joist (407). These FIGs. show a progressive of movement of various internal components that comprise the holding and advancing systems. Some of these systems are also shown in further detail in FIGS. 12 and 13. The holding system is described elsewhere herein. Also shown is a vertical motion actuator (641) and a pusher (645). The vertical motion actuator (641) is a structure that is vertically and slidingly installed in a channel at the top of the tool body (605) above the installation chamber (639). This element is tensioned upward by a spring as shown. When the driver bit (409) is lowered, the collar (637) will eventually contact the top of the actuator (641), and continuing to lower the driver bit (409) during installation will thus cause the actuator (641) to move downward from its neutral position, tensioning its spring. A bottom side of the depicted actuator (641) has an angled or beveled surface (673), shown as roughly 45 degrees (though other angles and shapes are possible), facing towards the back of the tool body (605). This angled surface (673) interfaces with a corresponding upward or top surface (675) of an actuator arm (667) extending from the main body (661) of the pusher (645). This top surface may be angled in an embodiment, such as having an angle corresponding to the angle of the vertical actuator (641) surface (673). This angle might be a complementary angle in an embodiment. The pusher (645) is slidingly (along the direction of the major axis) and pivotably attached at a pivot point, shown in the depicted embodiment on the bottom of the main body (661), to an interior surface of the tool body (605), and slides at the pivot point. Structures and techniques for this type of installation are well-known in the art. The depicted pusher (645) also has a tensioning arm (665) on the opposing side from the actuator arm (667), and the tensioning arm (665) is tensioned by a spring (647) braced against a rearward internal surface of the tool body (605). The pressure applied by the spring (647) tends to slide the pusher (645) forward, such that its neutral position places the distal end of the actuator arm (667) under the angled surface (673) of the vertical actuator (641).

The depicted pusher (645) is also tensioned by a lateral spring (663), which tends to pivot the pusher (645) inward towards the feed path. Stops may also be included to ensure that the pusher (645) is not tensioned or disposed in any direction beyond a desired amount. In neutral position with respect to the lateral spring (663), a pawl (651) of the pusher (651) extends partially into the feed path behind one of the fastener elements (103) in the clip strip (701).

The vertical motion actuator (641) is a structure that is vertically and slidingly installed in a channel at the top of the tool body (605) above the installation chamber (639). This element is tensioned upward by a spring as shown. When the driver bit (409) is lowered, the collar (637) will eventually contact the top of the actuator (641), and continuing to lower the driver bit (409) during installation will thus cause the actuator (641) to move downward from its neutral position, tensioning its spring. A bottom side of the depicted actuator (641) has an angled or beveled surface (673), shown as roughly 45 degrees (though other angles and shapes are possible), facing towards the back of the tool body (605). This angled surface (673) interfaces with a corresponding upward or top surface (675) of an actuator arm (667) extending from the main body (661) of the pusher (645). This top surface may be angled in an embodiment, such as having an angle corresponding to the angle of the vertical actuator (641) surface (673). This angle might be a complementary angle in an embodiment. The pusher (645) is slidingly (along the direction of the major axis) and pivotably attached at a pivot point, shown in the depicted embodiment on the bottom of the main body (661), to an interior surface of the tool body (605), and slides at the pivot point. Structures

When the vertical actuator (641) is moved toward during installation, its top surface (675) contacts that of the pusher (645), and forces the pusher (645) out of neutral position, sliding rearward towards the feed end of the tool body (605). This can be seen in FIG. 10A. Additionally, the outward lateral side of the pusher (645) may comprise an arcuate extension having a shape effective to cause the pusher (645) to pivot inwardly and outwardly as described herein. Because the depicted pusher (645) is both slidingly and pivotably attached to the tool body (605) (i.e., at the attaching point (653) shown in FIGS. 10A-10C), as the pusher (645) slides rearward, it may also pivot away from the feed path of the strip (701).

As shown in FIG. 10A, the pusher (645) also has a pawl (651) disposed on the internal lateral side (opposing the lateral spring), adjacent the feed path, with the pawl (651) having an angled element facing the back of the tool. Thus, as the pusher (645) is pushed back and pivoted away, this angled surface of the pawl (651) contacts the next rotating T-clip assembly (101) in the strip (701) and causes the pusher (645) to rotate away from the feed path, tensioned by the lateral spring (663). As shown in FIGS. 10D-10F, as the driver bit (409) continues to descend, the actuator (641) continues to push the pusher (645) toward the back of the tool body (605), and the pawl (651) continues to pivot the pusher (645) out of the feed path, until the pawl (651) has moved around the next rotating T-clip assembly (101) in the clip strip (701). As shown in FIGS. 10G-10I, once the fastener element (103) has been driven to its maximum extent (i.e., the bit collar (637) inhibits further downward motion), the pawl (651) has slipped behind the next assembly (101) in the strip (701) and the tension applied by the lateral spring (663) rotates the pusher (645) back into alignment, snapping the pawl (651) into position behind the next rotating T-clip assembly (101).

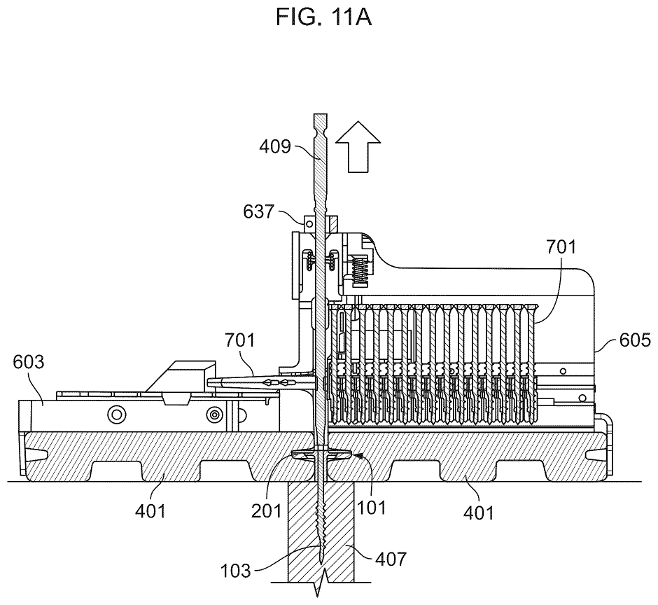

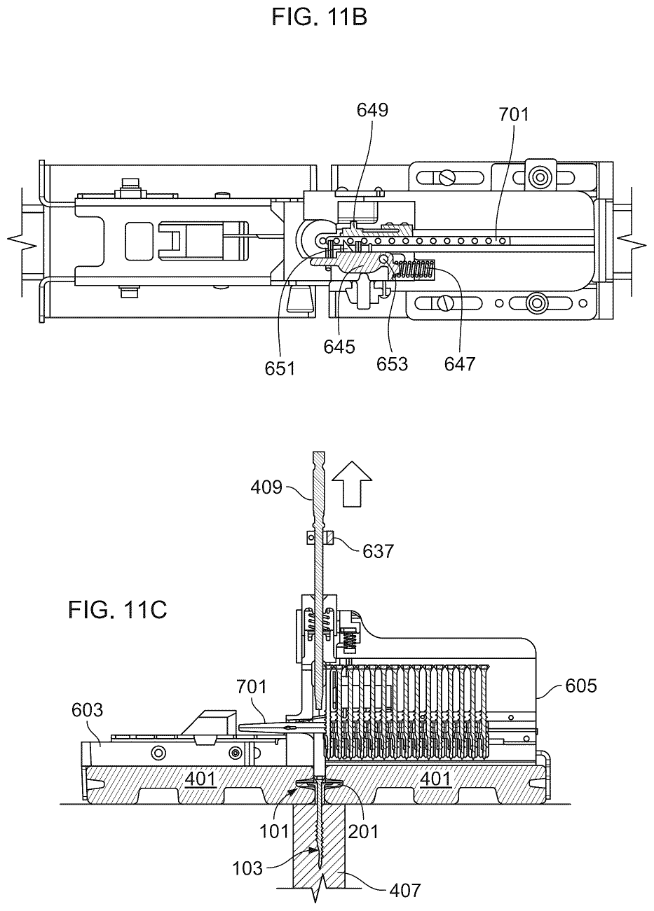

As shown in FIGS. 11A-11C, when the driver bit (409) is withdrawn, the actuator (641) reverses and moves upward to its neutral position due to the tensioning pressure of its spring (669), and the tensioning force applied by the tensioning element causes the pusher (645) to slide towards the front of the tool body (605). Since the pawl (651) is now disposed behind the next rotating T-clip assembly (101) in the strip (701), this motion causes the strip (701) to advance forward in the tool body (605).

The size and shape of the pusher (645), amount of tension, location and shape of stops (if any), and length of slide track for the pusher (645), among other elements, are effective to cause the strip (701) to advance such that the next clip (101) is loaded into the installation chamber (639). For example, the slide distance of the pusher (645) is effective to advance the next rotating T-clip assembly (101) into the installation chamber (639), where the installation process can restart. The installer then slides the tool (601) along the deck boards (401) to the next installation point.

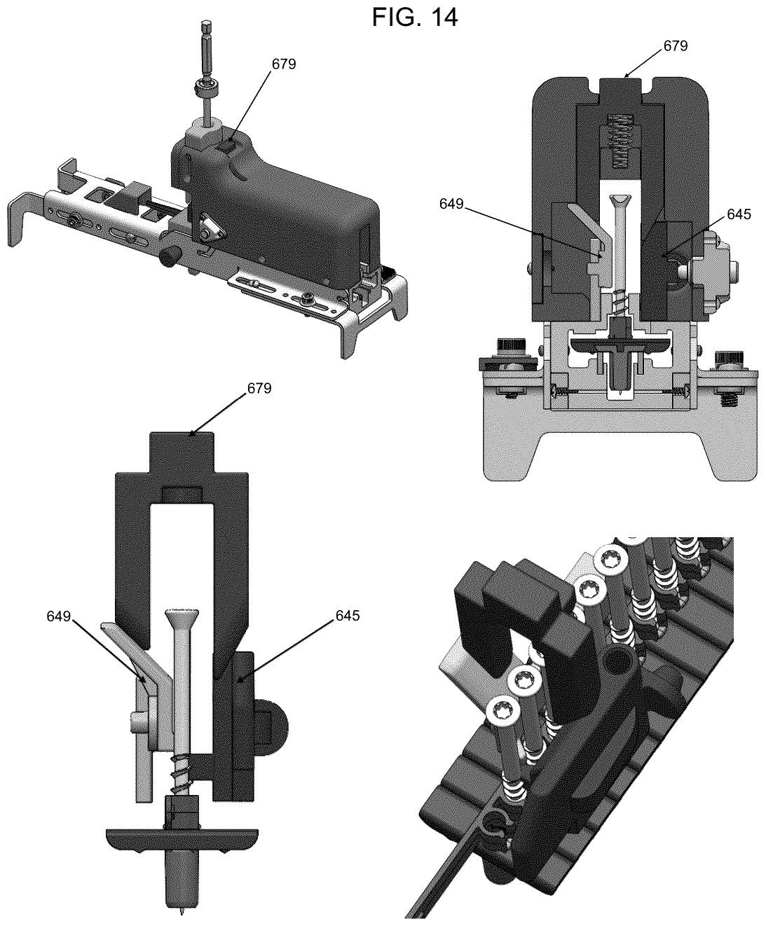

There may in some embodiments be a need or desire to remove a clip strip (701) before it is exhausted. In such cases, the exterior of the tool body (605) may include a release mechanism (679) having a button accessible to the user to operate the mechanism. An embodiment of such a release mechanism (679) is shown in FIG. 14. When the button is pressed, the release mechanism (679) lowers into the tool body. In the depicted embodiment, the release mechanism (679) is generally in the configuration of a fork having a button at the top end and two legs with angled surfaces which interact with the pusher (645) and holder (649) to pivot them away from the feed path, disengaging from the clip strip (701) such that it can be withdrawn from the feed channel.

Throughout this disclosure, geometric terms may be used to characterize, among other things, sizes, shapes, dimensions, angles, distances, and relationships. These terms may be used with qualifiers such as “generally,” “about,” and “approximately.” One of ordinary skill in the art will understand that, in the context of this disclosure, these terms are used to describe a recognizable attempt to conform a device or component to the qualified term. By way of example and not limitation, components described as being “generally coplanar” will be recognized by one of ordinary skill in the art to not be actually coplanar in a strict geometric sense because a “plane” is a purely geometric construct that does not actually exist and no component is truly “planer,” nor are two components ever truly coplanar. Variations from geometric descriptions are unavoidable due to, among other things, manufacturing tolerances resulting in shape variations, defects, imperfections, non-uniform thermal expansion, natural wear, minor variations that are nevertheless recognizable as the qualified term, and other deformations. One of ordinary skill in the art will understand how to apply geometric terms, whether or not qualified by relative terms such as “generally,” “about,” and “approximately,” to describe a reasonable range of variations from the literal geometric term in view of these and other considerations appropriate to the context.

Additionally, the use of the conjunctive and disjunctive should not necessarily be construed as limiting, and the conjunctive may include the disjunctive, and vice versa. Likewise, the recitation of components, or quantities of components, should not be understood as limiting unless otherwise specified; that is, reciting “an element” should be understood to mean “an element” is present, but should not be understood to implicitly exclude the presence of additional unrecited elements.

In this application, relative directional terms such as “up,” “down,” “inward,” “outward,” “descend,” and “ascend” and the like, are used to describe the positioning and movement of elements with respect to their orientation as depicted in the accompanying figures, and it should be understood that these terms are intended to provide a frame of reference based on the orientation of the object as shown in the drawings. For example, “outward” refers to movement away from the center of the object, and “inward” refers to movement toward the center. Similarly, directional terms such as “up” and “down” describe directions relative to the orientation in the figures and do not necessarily correspond to directions relative to gravity in real world embodiments, depending on how the elements are oriented in the real world. These directional terms are meant to facilitate an understanding of the invention as shown and should not be limited to any particular real-world orientation.

It will be understood that when components may be operated by springs, the springs and components in contact with them have a positions in which the springs are not materially tensioned. Sometimes called a “rest state” or “equilibrium state” in physics, this is a state of the physical systems in which major forces such as spring tension are balanced or inactive, and the resulting position of the device and/or individual components may be referred to as a “natural” or “neutral” position. Of note, one or more components may be in a neutral state at the same time that others are not.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A deck clip installation system comprising:
a clip strip comprising a plurality of deck installation clips removably attached to a backing;
a base element comprising:
a first end having a generally U-shaped cross-section comprising a top having two side rails extending downward from opposing lateral edges thereof, and a first adjustable gripping element;
a second end opposing said first end and defining a major axis extending from said first end to said second end, said second end comprising a second adjustable gripping element; and
a locking pin disposed through a side of one of said side rails;
wherein each of said two side rails extend to said second end and comprise a receiving notch disposed on a top side thereof and a locking notch disposed on a distal end thereof; and
a tool body comprising:
an installation chamber disposed within said tool body and adapted to receive a deck installation clip from said clip strip;
a channel disposed through said tool body from a front end proximal said first end to a back end proximal said second end, said channel intersecting said installation chamber and having a track on a bottom surface adapted to receive, and defining a feed path of, said clip strip;
a holder operable to inhibit movement of said clip strip through said channel toward said back end;
a pusher operable to reciprocally and incrementally advance said clip strip through said channel toward said front end;
a vertical actuator slidingly disposed in said tool body above said installation chamber, said vertical actuator comprising a vertical channel extending from a top side to a bottom side thereof, said vertical actuator vertically tensioned in said tool body by a spring;
a driver bit comprising a bit collar proximal a top end thereof, and an opposing bottom end disposed in said tool body, and an elongated body extending therebetween, at least part of said elongated body vertically slidingly disposed in said tool body, and at least part of said elongated body vertically slidingly disposed in said vertical channel of said vertical actuator;
a first set of engagement pins disposed on opposing lateral sides of said tool body proximal said front end and a second set of engagement pins disposed on opposing lateral sides of said tool body proximal said back end; and
a locking receiver disposed on a lateral said of said tool body;
wherein said tool body is removably attachable to said base element by sliding said first set of engagement pins into said receiving notches and sliding said second set of engagement pins into said locking notches until said locking pin engages said locking receiver.

2. The deck clip installation system of claim 1, wherein said base element further comprises at least one opening in said top side.

3. The deck clip installation system of claim 2, wherein said base element further comprises a strip guide on said top side.

4. The deck clip installation system of claim 3, wherein said first gripping element comprises a fin having a major plane generally perpendicular to said major axis, and an adjustable arm extending generally perpendicularly from said fin, said adjustable arm slidingly and adjustably attachable and lockable to one of said side rails by locking hardware.

5. The deck clip installation system of claim 4, wherein said second gripping element comprises at least one fin having a major plane generally perpendicular to said major axis, and at least one adjustable arm extending generally perpendicularly from said fin, said adjustable arm slidingly and adjustably attachable to an adjusting wing extending laterally outward from at least one of said side rails proximal to said second end.

6. The deck clip installation system of claim 5, wherein said holder is attached to an interior surface of said tool body on a first side of said channel and installation chamber, and comprises a flexing arm having a pawl at a distal end thereof, said pawl extending into said feed path when said arm is unflexed, and said pawl laterally movable out of said feed path when said flexing arm is flexed, said pawl sized and shaped to inhibit movement of a strip of deck installation clips disposed in said channel toward said back end.

7. The deck clip installation system of claim 6, wherein said bit collar has a radius larger than a radius of a top opening of said vertical channel in said vertical actuator.

8. The deck clip installation system of claim 7, wherein when said bit driver is lowered into said tool body a distance effective to cause said bit collar to contact said top opening, lowering said bit driver further causes said vertical actuator to be lowered into said tool body.

9. The deck clip installation system of claim 8, wherein when said lowered bit driver is raised from said tool body a distance effective to cause said bit collar to detach from said top opening, said spring causes said vertical actuator to be raised from said tool body to a neutral position.

10. The deck clip installation system of claim 8, wherein said vertical actuator comprises an angled surface on a bottom side thereof.

11. The deck clip installation system of claim 10, wherein said pusher comprises a main body pivotably attached to the interior of said tool body at a pivot point.

12. The deck clip installation system of claim 11, wherein said main body is slidingly, along said major axis, attached to said main body at said pivot point.

13. The deck clip installation system of claim 12, wherein said pusher further comprises an actuating arm extending from a first end of said main body proximal said front end, said actuating arm having an angled surface on a top side thereof.

14. The deck clip installation system of claim 13, wherein said pusher further comprises a tensioning arm extending from a second end of said body element opposing said first end and proximal said back end, said tensioning arm tensioned in the rearward direction against an interior surface of said tool body by a spring.

15. The deck installation system of claim 14, wherein said pusher further comprises a pawl extending from a lateral side of said main body, said pawl at least partially disposed in said feed path when said pusher is in a neutral position.

16. The deck installation system of claim 15, wherein said angled surface of said vertical actuator is disposed above said angled surface of said pusher in said tool body, and when said vertical actuator is lowered into said tool body a distance effective to cause said angled surface of said vertical actuator to contact said angled surface of said pusher, lowering said vertical actuator further causes said pusher to slide towards said back end and to pivot away from said feed path.

17. The deck installation system of claim 16, wherein when said pusher slides towards said back end and pivots away from said feed path to a maximum extent, said pawl advances said clip strip toward said front end a distance effective to advance a deck installation of said clip strip into said installation chamber.

18. The deck clip installation system of claim 17, wherein each of said deck installation clips comprises a rotating T-clip assembly.
